(19) United States
(12) Patent Application Publication
(10) Pub. No.: US 2024/0358047 A1
(43) Pub. Date: Oct. 31, 2024

(54) APPARATUS AND METHOD FOR DRYING PLANT AND ANIMAL FOODSTUFFS

(71) Applicant: WEALTH & RESEARCH TRADING LTD., TA'XBIEX (MT)

(72) Inventors: SONIA DE BORTOLI GAZZUOLA, TA'XBIEX (MT); VITTORIO COGO, TA'XBIEX (MT)

(21) Appl. No.: 18/577,553

(22) PCT Filed: Jul. 11, 2022
(86) PCT No.: PCT/IB2022/056396

§ 371 Date: Jan. 8, 2024

(30) Foreign Application Priority Data
Jul. 9, 2021 (IT) 102021000018191

(51) Int. Cl. A23L 3/54; A23L 3/00; A23L 3/015; A23L 3/18

(52) U.S. Cl. CPC A23L 3/54; A23L 3/001; A23L 3/0155; A23L 3/18

(57) ABSTRACT

A method and apparatus for drying foodstuffs of plant or animal origin that includes introducing the foodstuffs to be dried into a drying chamber for drying and heating the foodstuffs to a temperature which causes an evaporation of water contained in the foodstuffs until the amount of water contained in the foodstuffs is reduced to a predetermined value indicating that the foodstuffs are dried. The heating of the foodstuffs is performed by generating an oscillating magnetic field such that prior to said heating, the pressure inside said drying chamber is reduced to a predetermined value below atmospheric pressure.

The invention relates to an apparatus and method for drying foodstuffs of plant or animal origin, in particular to an apparatus and method for removing most of the water present in a foodstuff of plant or animal origin, so as to facilitate its preservation even over long periods, without undesirable fermentation and significant alteration of the nutritional and organoleptic properties of the foodstuff occur.

In the state of the art, two main processes are known to reduce the water content of a foodstuff of plant or animal origin: drying and lyophilisation.

Drying is a heat treatment of a foodstuff, solid or liquid, in order to remove almost all the water it contains, from a water content between 65% and 95% to a water content between 10% and 15%. Drying can be done by natural or artificial methods.

Natural methods, known since antiquity, are based on exposing the product (generally of plant origin, but also animal) to sun and air for weeks or months until the water it contains is almost completely eliminated.

These methods are still practised at the domestic and artisanal level mainly in hot-dry climate countries, sometimes associated with smoking to sterilise and flavour the treated foodstuff.

These natural methods have long since been completely abandoned in the food industry because they do not allow for product control, especially from a hygienic and organoleptic point of view, and are labour-intensive to turn products periodically.

Artificial methods involve the use of apparatuses or facilities called dryers, which comprise artificially heated environments in which the foodstuff to be processed is circulated or stands.

Industrial dried foodstuffs production processes generally involve three steps: washing, drying, packaging.

While preparation (in particular the washing, given the purely microbiostatic action of the treatment, the possible concentration of liquid products and the cutting into flakes, strips or cubes to facilitate drying) and packaging (in containers impermeable to light, air and above all humidity) are very important in view of the final result, the heart of a drying process remains the heat treatment aimed at eliminating almost all the water from the foodstuff.

With regard to heat treatment, two aspects are of paramount importance: the transfer of heat from the heating source to the product through convection, thermal conduction, and radiation, and the transfer of water from the product to the outside.

To optimise the transfer of water from the product to the outside, it is necessary to calibrate the heat treatment according to how the water is transferred from the foodstuff to the outside.

Initially, the water rapidly migrates from the innermost to the outermost layers of the foodstuff through the porosities of the foodstuff, and once it has reached the surface, it evaporates. In a second stage, as the larger channels dry out, the residual water slowly diffuses outwards through the foodstuff microporosities until it reaches a thermo-hygrometric equilibrium with the surrounding environment.

From a technological point of view, this means that the first phase can take place very quickly with a sharp rise in temperature. In the case of air heating methods, the air temperature can exceed 100-150° C. with a parallel increase in air speed and turbulence.

In the second phase, the temperature is lowered to just above room temperature so that the drying of the outer layers does not act as a barrier to moisture diffusion from the inner layers. Finally, it is necessary to keep the foodstuff in an environment as humidity-free as possible, for example with a relative humidity between 10% and 20%.

Known artificial drying methods mainly include: drying with hot air, drying by radiation and drying by direct contact of the foodstuff with a heated surface.

In hot-air drying, the hot air has a dual role, that of transmitting heat, causing the evaporation of water, and that of moving the steam itself away from the surface of the foodstuff and its surroundings. The result is optimised by increasing the temperature and speed of the air.

Drying by radiation involves passing the foodstuff carried on a conveyor belt under a source of infrared radiation or drying in microwave tunnel ovens.

In drying by direct contact with a heated surface, the foodstuff is heated by contact with a metal surface, which in turn is heated by contact with steam.

However, while drying by the known methods mentioned above is excellent for foodstuff preservation, it also brings certain disadvantages due to the high temperature to which the foodstuff is subjected. There is an almost total degradation of most of the vitamins in the product, resulting in a decrease in nutritional value. Proteins and carbohydrates undergo the Maillard reaction, which is as valuable in some cooking methods as it is harmful in preservation methods, because it can impart an unpleasant appearance and taste.

In addition, there are other disadvantages due to the fact that a dried foodstuff must be rehydrated before it is consumed. However the foodstuffs only reabsorb about two-thirds of their initial water and tend to be harder and chewier than they were originally. Some foodstuffs may take on a dark colour and a bitter taste.

Lyophilisation is high vacuum drying of a previously frozen foodstuff by the process of sublimation, i.e. the direct passage of water from the solid state (ice) to the vapour state.

Lyophilisation is mainly used to preserve a product that is not stable in solution, if it cannot be dried by thermal methods because it is thermolabile, to dry thermolabile products, to obtain a water-avid product, or to obtain a sterile powdered product from an already sterile product, as the lyophilisation process maintains the sterility of the product.

However, the lyophilisation process has a number of disadvantages: it is an expensive technique that is extremely inefficient in terms of energy, involving high energy consumption; it has a limited production capacity; it takes a long time, on average 1 to 4 days; moreover it is difficult to switch from laboratory to industrial-scale production.

Due to the aforementioned disadvantages, the lyophilisation process is normally used when the value of the product is sufficiently high, e.g. in the pharmaceutical field in the production of biotechnological drugs, vaccines, vitamins, antibiotics, liposomes and oncology products.

One purpose of the present invention is to provide a method of drying foodstuffs of plant or animal origin that makes it possible to reduce the time required for drying of foodstuffs without altering the nutritional and organoleptic properties of the dried foodstuffs, in particular without degrading the vitamins and altering the proteins and carbohydrates contained in the foodstuffs.

Another purpose of the present invention is to provide a method of drying foodstuffs of plant or animal origin that makes it possible to obtain a product with uniform characteristics throughout its whole mass. A further purpose of the present invention is to provide a method of drying foodstuffs of plant or animal origin that makes it possible to reduce the energy consumption required per mass unit of dried foodstuff.

A yet further purpose of the present invention is to provide an apparatus for drying foodstuffs of plant or animal origin according to the method of the present invention, which that makes it possible to dry the widest variety of foodstuffs and which has low operating costs.

The purposes of the invention are achieved by a method for drying foodstuffs of plant or animal origin according to claim 1 and by an apparatus for drying foodstuffs of plant or animal origin according to claim 10.

The method and apparatus according to the present invention realise the drying of foodstuffs of plant or animal origin by heating the foodstuffs by means of electromagnetic waves at a frequency between 10 Mhz and 100 Mhz in a vacuum environment, i.e. an environment in which a pressure below atmospheric pressure is maintained.

As will be explained in more detail below, the method and apparatus according to the invention make it possible to dry foodstuffs by heating them at temperatures low enough to not cause degradation of vitamins and alteration of the proteins and carbohydrates contained in the foodstuffs, thus substantially maintaining the nutritional and organoleptic properties of the foodstuffs.

Foodstuffs heating is quick and uniform without thermal gradients forming within the foodstuffs, resulting in better and faster elimination of the water they contain.

The energy efficiency of the method and apparatus is much better than that of known drying methods and apparatuses, because the drying of foodstuffs can take place at low temperatures, so that the energy consumption required to heat the foodstuffs to be dried is greatly reduced.

The environmental impact is minimal as there is very low heat dissipation in the environment because the heat for drying foodstuffs is generated within the foodstuffs itself and no heat carrier medium is required, and there is also no production of fumes or vapours.

Further features and advantages of the invention will result from the following description of some examples of embodiments of the invention, made for illustrative and non-limiting purposes only, with reference to the accompanying drawings, wherein

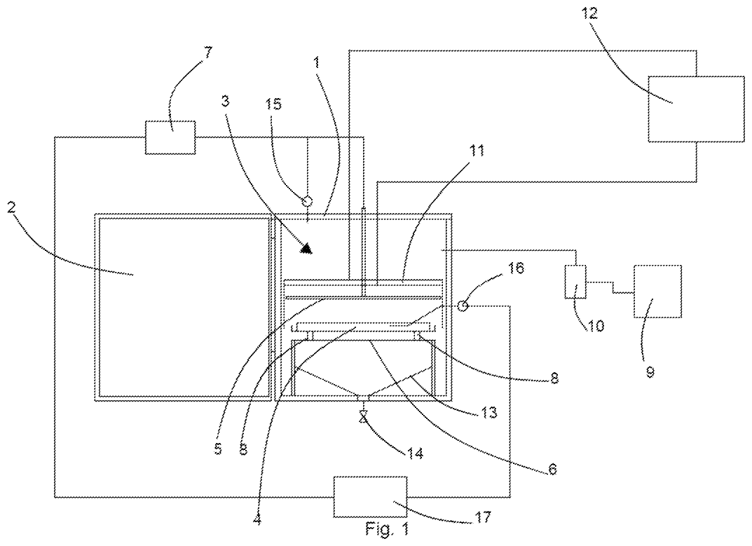

FIG. 1 is a schematic view of an apparatus according to the invention, in a first version particularly suitable for laboratory tests;

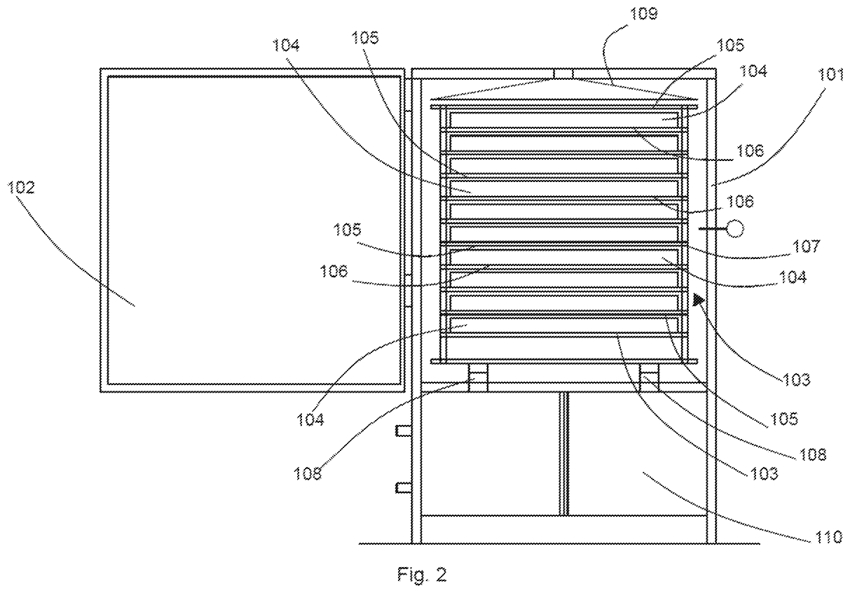

FIG. 2 is a schematic view of a second version of an apparatus according to the invention, suitable for industrial-scale production;

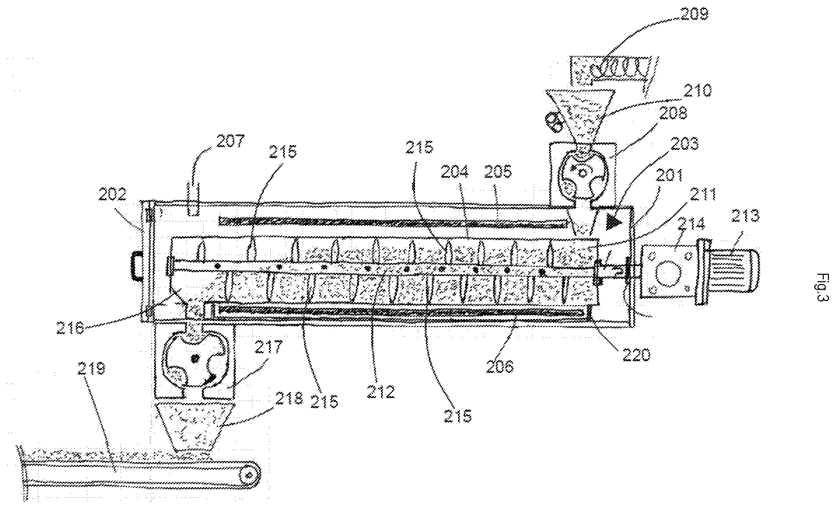

FIG. 3 is a schematic view of a third version of an apparatus according to the invention, suitable for continuous industrial-scale production.

FIG. 1 schematically illustrates a first version of an apparatus according to the invention for drying foodstuffs of plant or animal origin. This first version of the apparatus is particularly suitable for laboratory tests.

The apparatus comprises a watertight casing 1, equipped with a door 2, which is also watertight, through which the foodstuffs to be dried can be introduced into a drying chamber 3 defined within the casing 1. In the drying chamber 3, a support element 4 is arranged on which the foodstuffs to be dried are placed.

The supporting element 4 is placed between a first positive electrode 5, connected to an electromagnetic radiation generator 7, capable of generating an electromagnetic field with a frequency between 10 Mhz and 100 Mhz, and a second negative electrode 6 connected to ground.

Preferably, the apparatus according to the invention comprises heating means for heating the inorganic and organic compounds in the drying chamber 3. Such heating means comprise at least a first generator of electromagnetic waves with at least one first frequency f1 and/or at least a second generator of electromagnetic waves with at least one second frequency f2 lower than the first frequency f1 of the electromagnetic waves emitted by the first generator.

In particular, in one possible embodiment, the first generator of electromagnetic waves with at least one first frequency f1 comprises a generator of high-frequency electromagnetic waves with a frequency f1 between 900 MHZ and 3000 MHZ, preferably between 915 MHz and 3000 MHz, while the second generator of electromagnetic wavs with the at least one second frequency f2 comprises a generator of low-frequency electromagnetic waves with a frequency f2 between 10 MHz and 920 Mhz, preferably between 10 MHz and 914 MHz.

The first generator is a high-frequency electromagnetic wave generator known in technology as a solid-state generator.

The first and second generators can operate individually, alternately or simultaneously, depending on the product or compound and the type of drying to be carried out.

Support element 4 is made of a material that is transparent to electromagnetic waves in the 10 Mhz to 100 Mhz frequency band.

For example, the support element can be made of POM, PP, PIC, ceramic, glass.

The support element 4 is mounted on a load cell system 8, by means of which the weight loss of the foodstuffs placed on support element 4, due to the evaporation of the water contained in them, during the drying process, can be detected.

The drying chamber 3 is connected to a vacuum pump 9, by means of which air can be sucked in from the drying chamber 3 to put it under vacuum. Between the drying chamber 3 and the vacuum pump 9 there is a filter 10, which prevents any foodstuff residues present in the air from reaching the vacuum pump and damaging it.

In a possible embodiment, the drying chamber 3 is connected to pressure regulating means comprising at least one vacuum pump 9 suitable for sucking in fluids from the drying chamber 3 towards the external environment in order to put it under vacuum, and at least one regulating valve suitable for delivering air from the environment towards the inside of the drying chamber 3 in order to increase the pressure value inside the drying chamber 3.

In addition, the means of pressure regulation may also include a pressure gauge 15, or vacuum gauge, which is used to measure the vacuum created inside the drying chamber 3 by the vacuum pump 9 during the drying process.

As will be better described below, it should be noted that the vacuum pump 9 and the regulating valve can be used alternatively: for example, in the event that the pressure gauge or vacuum gauge 15 detects a lower pressure value than desired, the vacuum pump 9 can be switched off, and the regulating valve can be operated to introduce air at atmospheric pressure into the drying chamber 3, in order to increase the pressure value inside the chamber.

Thus, the means of pressure regulation can be operated to adjust the pressure value inside the drying chamber 3 in such a way that the pressure is maintained at a constant value during the drying operation, or in such a way that the pressure assumes a variable value, for example between at least a minimum pressure value and at least a maximum pressure value during the duration of the drying operation.

A cooling coil 11, fed by a refrigeration unit 12, is also arranged in the drying chamber 3. The cooling coil 11 serves to condense the moisture, which evaporates from the foodstuffs during the drying process. The condensed moisture is collected in a collection tank 13, from which it can be discharged through a drain valve 14.

The apparatus according to the invention is further equipped with a pressure gauge 15, or vacuum gauge, which serves to measure the vacuum created inside the drying chamber 3 by the vacuum pump 9, with a temperature sensor 16, for example an optical temperature sensor, which serves to measure the temperature reached by the foodstuffs during the drying process, and with a PLC 17 which controls the drying process.

The operation of the apparatus described in FIG. 1 is as follows: after introducing the foodstuffs to be dried into the drying chamber 3 by placing them on the support element 4, the vacuum pump 9 is started up until a pressure of a predetermined value below atmospheric pressure is obtained inside the drying chamber 3. Since, as is known, the evaporation temperature of the water depends on the pressure and decreases as the pressure decreases, the value of the pressure inside the drying chamber 3 is selected so as to obtain the evaporation of the water, contained in the inorganic and organic compounds to be dried, at a temperature from −40° C. to +99.8° C., preferably between −22° C. and +70° C., more preferably between 5° C. and 45° C.

In one embodiment, the value of the pressure inside the drying chamber 3 is selected so as to obtain evaporation of the water, contained in the inorganic and organic compounds to be dried, at a temperature that does not damage vitamins and does not degrade proteins and carbohydrates contained in said organic compounds, and that does not cause structural damage or inappropriate chemical reactions in said inorganic compounds, in particular at a temperature between 5° C. and 45° C. Since, as is well known, the evaporation temperature of water is pressure-dependent and decreases as the pressure decreases, the predetermined value of the pressure inside drying chamber 3 is selected so as to obtain evaporation of the water, contained in the foodstuff to be dried, at a temperature that does not damage vitamins in the foodstuff and does not degrade proteins and carbohydrates. For example, the pressure inside the drying chamber 3 can be selected so that the foodstuffs can be dried at a temperature of no more than 40/45° C., with the possibility of drying at very low temperatures, for example as low as 5° C., by reducing the pressure inside the drying chamber 3 down to about 9 mbar.

In one embodiment, the pressure value inside drying chamber 3 can be between 0.01 mbar and 999 mbar, preferably between 0.05 mbar and 999 mbar, more preferably between 9 mbar and 100 mbar. After the desired pressure is reached inside the drying chamber 3, the vacuum pump 9 is stopped and the electromagnetic radiation generator 7 is started, which generates between the positive electrode 5 and the negative electrode 6 an oscillating electromagnetic field with a frequency between 10 Mhz and 100 Mhz. It is particularly preferred to use a frequency of the oscillating magnetic field between 27 Mhz and 28 Mhz, with which there is optimal control of the heating of the foodstuff to be dried.

The foodstuffs to be dried, placed on the support element 4, are hit by the oscillating electromagnetic field, which causes the water contained within them to heat up to the evaporation temperature of the water at the pressure inside the drying chamber 3. The value of the pressure inside the drying chamber 3 is selected so that the evaporation temperature of the water at that pressure is lower than temperature values that could damage the vitamins, or degrade the proteins and lipids present in the foodstuff to be dried.

The achievement of the evaporation temperature of the water at the pressure present inside the drying chamber 3 is detected by the temperature sensor 16.

When the evaporation temperature is reached, the evaporation process of the water in the foodstuff begins, which is transformed into steam that expands inside the drying chamber 3, then condenses in contact with the cooling coil 11 and is collected in the tank 13 from which the condensate can be discharged through the drain valve 14.

The achievement of the desired degree of drying, i.e. the percentage of residual moisture in the foodstuffs, is detected by measuring the weight loss of the foodstuffs using the load cell system 8. In fact, the decrease in weight measures the amount of evaporated water and, consequently, the decrease in the moisture content of the foodstuffs.

When the measured decrease in weight indicates that the residual moisture of the foodstuffs has reached a desired value, the apparatus is stopped.

The apparatus according to the invention can operate in two different modes.

A first mode, which may be referred to as on-off mode, which consists in heating the foodstuffs, by means of the oscillating electromagnetic field generated by the generator 7, up to the evaporation temperature of the water at a predetermined pressure inside the drying chamber 3. Turn off the generator 7 and start the vacuum pump 9 until said predetermined pressure is reached inside the drying chamber 3, so that the evaporation of the water contained in the foodstuffs begins. At the end of the evaporation, the generator 7 is restarted until the temperature of the foodstuffs is restored to the evaporation temperature and, if necessary, the vacuum pump is restarted to restore the predetermined pressure value inside the drying chamber 3 so that the evaporation of the water begins again, and so on until a desired residual moisture content in the foodstuffs is reached.

A second mode of operation involves operating the electromagnetic radiation generator 7 and vacuum pump 9 simultaneously in order to keep the system in equilibrium at a predetermined pressure and evaporation temperature, controlling the operation of generator 7 and vacuum pump 9 via PLC 17.

The means of pressure regulation can be operated in two different ways,

According to a first mode MP1, pressure regulation means are operated to maintain the pressure inside the drying chamber 3 at a constant value during the entire duration of the drying operation.

According to a second to mode MP2 the pressure regulation means are operated to vary the pressure inside the drying chamber 3 between at least a minimum pressure value and at least a maximum pressure value during the entire duration of the drying operation. Preferably, the minimum pressure value is about 1 mbar, and the maximum pressure value is about 50 mbar.

In one embodiment, wherein the apparatus comprises a first generator of electromagnetic waves with at least one first frequency f1 and/or at least a second generator of electromagnetic waves with at least one second frequency f2 lower than the first frequency f1, of the electromagnetic waves emitted by the first generator, the apparatus according to the invention can operate according to four different modes. As mentioned above, the first generator of electromagnetic waves with the at least one first frequency f1 comprises a generator of high-frequency electromagnetic waves with a frequency f1 between 900 MHz and 3000 MHZ, preferably between 915 MHz and 3000 MHz, while the second generator of electromagnetic waves with the at least one second frequency f2 comprises a generator of low-frequency electromagnetic waves with a frequency f2 between 10 MHZ and 920 Mhz, preferably between 10 MHz and 914 MHz.

The above-mentioned four possible modes of operation are described below:

### Mode 1

In this mode of operation, the means of pressure regulation are operated according to the above-described MP1 mode to maintain the pressure inside the drying chamber 3 at a constant value during the entire duration of the drying operation.

Depending on the product or compound to be dried and the type of drying desired, the optimum pressure value and the optimum frequencies for performing the heating and drying operation are selected.

In one embodiment, the selection of optimal frequencies is performed by scanning the product or compound to be dried by electromagnetic wave generators that detect which frequency develops the highest yield based on the percentage of reflected power, as described above.

In a further embodiment, this selection can be done by the control unit 17 in which drying recipes for different types of inorganic and organic compounds can be stored.

Once optimum pressure and frequency values have been defined, the pressure regulating means are operated to maintain the selected pressure value inside the drying chamber, and the first and/or second electromagnetic wave generator are operated to generate an electromagnetic field with the selected optimum frequency value, which will be maintained during the entire drying process.

According to such first mode, the inorganic and organic compounds are heated by the electromagnetic field generated by at least one of the electromagnetic wave generators, up to the evaporation temperature of the water, at a predetermined pressure inside the drying chamber 3. In particular, the pump 9 is started until the predetermined pressure inside the drying chamber 3 is reached, so that evaporation of the water contained in the inorganic and organic compounds begins. Evaporation ends when a desired residual moisture content in the inorganic and organic compounds is reached.

Mode 1 therefore operates using a constant vacuum value and constant frequency.

### Mode 2

In this mode of operation, the means of pressure regulation are operated according to the above-described MP1 mode to maintain the pressure inside drying chamber 3 at a constant during the entire duration of the drying operation.

Depending on the product or compound to be dried and the type of drying desired, the optimum pressure value and the optimum frequencies for performing the heating and drying operation are selected.

In one embodiment, the selection of optimal frequencies is performed by scanning the product or compound to be dried by electromagnetic wave generators that scan the electromagnetic waves and select the frequencies that produce a yield greater than 90%. Said generators sequentially emit a series of sample signals and select the signals that produce a signal return of less than 10%.

In one embodiment of such second mode, once the scanning is complete, at least one electromagnetic wave generator selected by the operator according to the product to be dried, begins to deliver power, varying the frequency of the electromagnetic wave generated by selecting in each case a frequency value from those previously selected, which allow a minimum yield of 90%, at predetermined intervals that can be set, for example, by a control and command panel in the apparatus.

As an example, if the product has an irregular shape, the high-frequency generator will be activated, if the product has a regular shape, the low-frequency generator will be activated.

As an example, the generated frequencies can be varied at selected time intervals between 1 and 300 seconds, preferably between 10 and 200 seconds, more preferably between 20 and 120 seconds. The at least one electromagnetic wave generator continues to deliver power for a predefined time interval, which can be set from the control and command panel, after which a new scan of the product or compound is performed to determine, based on the new product or compound characteristics detected (in particular residual weight and percentage of residual water), a new range of optimal frequencies that produce the maximum yield considering the amount of residual water present in the product.

In fact, upon drying, the dielectric properties of the product change, so the most effective frequencies for heating it also change accordingly.

Mode 2 therefore operates using a constant vacuum value and variable frequency.

### Mode 3

In this mode of operation, the means of pressure regulation are operated according to the above-described MP2 mode to vary the pressure inside the drying chamber 3 between at least a minimum and at least a maximum pressure value during the duration of the drying operation.

Preferably the minimum pressure value is about 1 mbar and the maximum pressure value is about 999 mbar.

In one embodiment, the pressure value varies between at least a minimum and at least a maximum value in times that can be set by a control and command panel.

Again, as in mode 2, in one embodiment the selection of optimal frequencies is performed by scanning the best frequencies to be used and selecting the frequencies that produce a yield greater than 90%.

In one embodiment of such third mode, once the scanning is complete, at least one electromagnetic wave generator selected by the operator according to the product to be dried, begins to deliver power, varying the frequency of the electromagnetic wave generated by selecting in each case a frequency value from those previously selected, which allow a minimum yield of 90%, at predetermined intervals that can be set, for example, by a control and command panel in the apparatus.

As an example, the generated frequencies can be varied at selected time intervals between 1 and 300 seconds, preferably between 10 and 200 seconds, more preferably between 20 and 120 seconds. The at least one generator continues to deliver power for a predefined time interval, which can be set from the control and command panel, after which a new scan of the product or compound is performed to determine, based on the new product or compound characteristics detected (in particular residual weight and percentage of residual water), a new range of optimal frequencies that produce the maximum yield considering the amount of residual water present in the product.

In fact, upon drying, the dielectric properties of the product change, so the most effective frequencies for heating it also change accordingly.

Mode 3 therefore operates using pulsating vacuum and variable frequency.

### Mode 4

In such operating mode, the means of pressure regulation are operated according to the above-described MP2 mode to vary the pressure inside the drying chamber 3 between at least a minimum and at least a maximum pressure value during the duration of the drying operation.

Preferably the minimum pressure value is about 1 mbar and the maximum pressure value is about 999 mbar.

As in modes 2 and 3, the optimal frequency value is varied by successive scans of the product or compound.

After the product or compound in the chamber has been heated, the at least one generator is switched off and the pressure regulation means are operated to bring the pressure inside the drying chamber 3 to a value as close as possible to 0 mbar in order to evaporate as much water as possible by rapidly decreasing the evaporation temperature of the water.

Then, after reaching this pressure value close to about 0 mbar, the pressure is restored to the starting value between 100 and 999 mbar, and the at least one generator is operated again to heat the product or compound.

The process is repeated until the product reaches the desired moisture content.

Mode 4 therefore operates using alternating pulsating vacuum and variable frequency.

In all four modes described, the inorganic and organic compounds to be dried, placed on the support element inside the drying chamber 3, are hit by the electromagnetic field generated by the at least one wave generator, which causes the water contained within them to heat up to the evaporation temperature of the water at the pressure inside the drying chamber 3.

The pressure value inside the drying chamber 3 is selected so that the evaporation temperature of the water at that pressure is lower than temperature values that could change the chemical-physical and structural properties of the treated product.

Particularly with regard to organic compounds and products, the temperature is selected within values suitable for not damaging the vitamins, or degrading the proteins and lipids present, preferably between −40° and 45°, preferably between −22° C. and +70° C., more preferably between 5° C. and 45° C. Particularly with regard to inorganic products and compounds, the temperature is selected within values that do not change the physical chemical structure of the product or compound, so preferably between −40° and +99.8° C., preferably between −22° C. and +70° C., more preferably between 5° C. and 45° C.

The achievement of the evaporation temperature of the water at the pressure inside drying chamber 3 is detected by a temperature sensor.

When the evaporation temperature is reached, the evaporation process of the water in the inorganic and organic compounds begins, which turns into steam that expands inside the drying chamber 3.

The steam generated is conveyed outside the drying chamber and condensed by the use of a condensate separation device and collected in a container through a drain valve.

The achievement of the desired degree of drying, i.e. the percentage of residual moisture in the inorganic and organic compounds, is detected by measuring the decrease in weight of the inorganic and organic compounds using the load cell system. In fact, the decrease in weight measures the amount of evaporated water and, consequently, the decrease in moisture content of the inorganic and organic compounds.

FIG. 2 illustrates a second version of an apparatus according to the invention, suitable for industrial production.

This second version of the apparatus is particularly suitable for small and medium-sized productions and operates similarly to the first version of the apparatus described above.

In this second version, the apparatus according to the invention comprises a watertight casing 101, equipped with a door 102, which is also watertight, through which the foodstuff to be dried can be introduced into a drying chamber 103 defined within the casing 1. In the drying chamber 103, a support frame 107 is arranged, which supports a plurality of electrode pairs 105, 106. Each electrode pair comprises a positive electrode 105, connected to an electromagnetic wave generator not visible in the figure, and a negative electrode 106 connected to ground.

The electromagnetic wave generator is designed to generate an oscillating electromagnetic field at a frequency between 10 Mhz and 100 Mhz.

A support element 104 on which the foodstuffs to be dried are placed is arranged between the electrodes of each pair. The support element 104 is made of a material that is transparent to electromagnetic waves in the 10 Mhz to 100 Mhz frequency band, for example glass or nylon mesh.

The support frame 107 is mounted on a load cell system 108, by means of which it is possible to detect the weight loss of the foodstuffs placed on the support elements 104, due to the evaporation of the water they contain, during the drying process.

In the upper part of the drying chamber 103 is located a suction hood 109, which overhangs the support frame 107 and is connected to a vacuum pump, not visible in the figure.

By means of the suction hood 109, the vacuum pump sucks air from the drying chamber 103 in order to obtain a predetermined pressure value inside the drying chamber 103, which is lower than atmospheric pressure, said pressure value being selected so that the evaporation temperature of the water contained in the foodstuffs arranged on the support elements 104 drops to a value such that the drying of the foodstuffs can be achieved without damaging the vitamins and without degrading the proteins and carbohydrates contained therein.

For example, the pressure inside the drying chamber 103 can be selected so that the foodstuffs can be dried at a temperature of no more than 40/45° C., with the possibility of drying also at very low temperatures, for example as low as 5° C., by reducing the pressure inside the drying chamber 103 down to about 9 mbar. Moisture produced by the evaporation of the water contained in the foodstuffs can be sucked in through the suction hood 109 to prevent the formation of condensate in the drying chamber 103.

Under the casing 1, a housing 110 can be provided to house the electromagnetic wave generator, the vacuum pump and a chiller device to condense the moisture sucked in through the hood 109.

The operation of the second version of the apparatus shown in FIG. 2 is similar to the operation of the first version of the apparatus shown in FIG. 1, to whose description we refer.

The difference with the first version of the apparatus shown in FIG. 1 is that in the second version of the apparatus, shown in FIG. 2, a much larger quantity of foodstuffs to be dried can be loaded compared to the first version of the apparatus shown in FIG. 1, because the foodstuffs are loaded on several levels, on the plurality of supporting elements arranged in the drying chamber 103.

Foodstuffs to be dried can be loaded onto the supporting elements 104 with the aid of trolleys, not shown.

Although the loading and unloading of foodstuffs into the drying chamber 103 must be done manually by an operator, the second version of apparatus according to the invention, shown in FIG. 2, allows a productivity between 20 kg/h and 200 kg/h of dried product.

In the second version, the apparatus according to the invention may comprise a plurality of drying units operating in parallel, depending on the desired productivity.

FIG. 3 illustrates a third version of an apparatus according to the invention, designed for continuous production.

The apparatus comprises a watertight casing 201, equipped with an access door 202 which is also watertight. A drying chamber 203 is defined within the casing 201, within which foodstuffs drying takes place.

Inside the drying chamber 203 is arranged a supporting element in the form of a basin 204 intended to receive the foodstuff to be dried. The basin 204 is placed between a first positive electrode 205, connected to an electromagnetic wave generator (not visible in the figure), and a second negative electrode 206, connected to ground. The electromagnetic wave field generator is used to generate between the first electrode 205 and the second electrode 206 an electromagnetic field oscillating at a frequency between 10 Mhz and 100 Mhz, preferably at a frequency between 27 Mhz and 28 Mhz which, as mentioned above, allows optimal control of the heating of the foodstuff to be dried.

The basin 204 is made of a material that is transparent to electromagnetic waves in the 10 Mhz to 100 Mhz frequency band.

The drying chamber 203 is connected to a vacuum pump, not visible in the figure, by means of a suction duct 207 through which the vacuum pump can suck air from the drying chamber 203 in order to obtain inside the drying chamber 203 a predetermined pressure value, lower than atmospheric pressure, said pressure value being selected so that the evaporation temperature of the water contained in the foodstuffs introduced into the basin 204 drops to a value such that the drying of the foodstuffs can be obtained without the vitamins being damaged and without the proteins and carbohydrates contained therein being degraded.

Advantageously, the pressure inside the drying chamber 203 can be reduced to a value between about 9 mbar and about 100 mbar, which corresponds to an evaporation temperature of the water contained in the foodstuff between about 5° C. and about 45° C. In this way, the drying of foodstuff can take place at low temperatures that do not damage the foodstuffs in any way during the drying process.

The foodstuffs to be dried are fed into a first end 211 of the basin 204 through a first star valve 208, fed by a dosing device 209, through a first hopper 210.

The purpose of the first star valve 208 is to isolate the drying chamber 203 from the external environment, so that a pressure value below atmospheric pressure can be maintained inside the drying chamber 203.

Arranged inside the basin 204 is a stirring device consisting of a shaft 212, driven to rotate about its longitudinal axis by a motor 213 and a gear reducer 214. The shaft 212, which is also made of a material transparent to the electromagnetic waves generated by the electromagnetic wave field generator, is provided with a plurality of paddles 215 shaped to advance the foodstuffs towards a second end 216 of the basin 204, when the shaft 212 is set to rotate.

The second end 216 of the basin 204 communicates with a second star valve 217 through which the dried foodstuffs can be discharged outside the drying chamber 203, for example into a second hopper 218 and onto a conveyor belt 219 which transports the dried foodstuffs to further processing.

The purpose of the second star valve 217 is also to isolate the drying chamber 203 from the external environment, so that a pressure value below atmospheric pressure can be maintained inside the drying chamber 203.

The operation of the apparatus illustrated in FIG. 3 is as follows: the dried foodstuffs introduced into the basin 204 through the first star valve 208 are in an environment with a pressure of between about 9 mbar and about 100 mbar, obtained by sucking in air from the drying chamber 203 by means of the vacuum pump external to the system, and are subjected to an increase in temperature due to the action of the oscillating electromagnetic field generated between the first electrode 205 and the second electrode 206 by the electromagnetic wave generator. The action of the oscillating electromagnetic field causes heating and consequent evaporation of the water present in the foodstuffs to be dried, which evaporation takes place at a temperature dependent on the pressure inside the drying chamber 203, i.e. at a temperature dependent on the pressure inside the drying chamber 3, advantageously a temperature between about 5° C. and about 45° C., with a pressure between about 9 mbar and about 100 mbar.

The transit of foodstuffs through basin 204 lasts between 20 and 60 minutes, depending on the type of foodstuff to be dried and the final residual moisture to be achieved, which can be between 1% and 20% by weight.

Once the drying process is finished, the foodstuffs are discharged outside the drying chamber 203, e.g. onto the conveyor belt 219, through the second star valve 217.

The drying chamber 203 can be opened through the watertight door 202, after the atmospheric pressure inside the drying chamber 203 has been restored, and the entire basin 204 can be extracted, for example for maintenance operations, by sliding it on support and sliding rails 220, provided inside the drying chamber 204.

The versions of the apparatus illustrated in FIGS. 2 and 3 can also be equipped with pressure detecting means, to measure the pressure inside the drying chamber (103; 203), temperature detecting means, to measure the temperature reached by the foodstuffs during the drying process, and chiller means to condense the moisture evaporated from the foodstuffs.

1. A method for drying foodstuffs of plant or animal origin comprising introducing the foodstuffs to be dried into a drying chamber of an apparatus for drying said foodstuffs; heating said foodstuffs to a temperature such to cause an evaporation of water contained in said foodstuffs; maintaining said temperature until the amount of said water contained in said foodstuffs is reduced to a predetermined value indicating that the foodstuffs are dried; extracting the evaporated water from said drying chamber; extracting the dried foodstuffs from said drying chamber, wherein said heating is performed by generating an oscillating magnetic field which hits said foodstuffs, that, prior to said heating, the pressure inside said drying chamber is reduced to a value lower than atmospheric pressure, between 0.01 mbar and 999 mbar, said value being selected so that the evaporation of the water contained in said foodstuffs takes place at a drying temperature sufficiently low so as to not damage nutritional and organoleptic properties of said foodstuffs, wherein said oscillating magnetic field has a frequency between 10 Mhz and 3000 Mhz.

2. The method according to claim 1, wherein said frequency is between 27 Mhz and 28 Mhz.

3. The method according to claim 1, wherein said drying temperature is between about −40° C. and 99.8° C.

4. The method according to claim 1, wherein said foodstuffs are placed inside said drying chamber on at least one support element made of a material transparent to the electromagnetic waves of said oscillating magnetic field.

5. The method according to claim 1, wherein said oscillating electromagnetic field is generated between at least one electrodes pair comprising a first electrode connected to an electromagnetic wave generator and a second electrode connected to ground.

6. The method according to claim 1, further comprising loading said foodstuffs onto said support element, at a first end of said support element; advancing said foodstuffs onto said support element between said first end and a second end of said support element; and discharging said foodstuffs from said support element at said second end.

7. The method according to claim 6, wherein said advancing takes place within a time interval between 20 minutes and 60 minutes.

8. The method according to claim 1, further comprising condensing the evaporated water from said foodstuffs.

9. The method according to claim 1, wherein at the end of said drying, the residual moisture contained in said foodstuffs is between 1% and 20% by weight.

10. An apparatus for drying foodstuffs of plant or animal origin, comprising a casing within which a drying chamber, heating means for heating said foodstuffs in said drying chamber, wherein the fact that said casing is made watertight, wherein said drying chamber is connected to vacuum generating means, suitable for reducing a pressure inside said drying chamber to a value below atmospheric pressure; that said heating means comprise at least one pair of electrodes and a generator of electromagnetic waves, wherein said at least one pair of electrodes comprises a first electrode connected to said generator of electromagnetic waves and a second electrode connected to ground.

11. The apparatus according to claim 10, further comprising at least one support element on which the foodstuffs to be dried can be arranged, said at least one support element being arranged inside said drying chamber between said at least one pair of electrodes.

12. The apparatus according to claim 11, wherein said support element is made of a material transparent to electromagnetic waves generated by said generator of electromagnetic waves.

13. The apparatus according to claim 11, wherein said support element comprises a plurality of support elements, wherein said at least one pair of electrodes comprises a plurality of electrode pairs, wherein each support element of said plurality of support elements is located between an electrode pair of said plurality of electrode pairs.

14. The apparatus according to claim 10, further comprising weight detecting means configured to measure a decrease in weight of said foodstuffs during said drying.

15. The apparatus according to claim 13, wherein said at least one support element is in the form of a basin within which is arranged a stirring device comprising a shaft, operable to rotate about a longitudinal axis thereof, wherein the shaft is provided with a plurality of paddles shaped to advance the foodstuffs introduced into the basin between a first end of the basin and a second end of the basin, when the shaft is set to rotate.

16. The apparatus according to claim 15, wherein said shaft is made of a material transparent to the electromagnetic waves generated by said generator of electromagnetic waves and is driven to rotate by a motor via a gear reducer.

17. The apparatus according to claim 15, further comprising a first star valve through which said foodstuffs can be introduced into said drying chamber at the first end of the basin.

18. The apparatus according to claim 15, further comprising a second star valve through which said foodstuffs, at the end of said drying, can be extracted from the drying chamber at the second end of the basin.

19. The apparatus according to claim 10, wherein said drying chamber is provided with a watertight door.

20. The apparatus according to claim 10, further comprising pressure detecting means configured to measure the pressure inside said drying chamber and temperature detecting means configured to measure the temperature of said foodstuffs inside said drying chamber and chiller means suitable for condensing moisture evaporated from said foodstuffs during their drying.
